(19) United States
(12) Patent Application Publication
(10) Pub. No.: US 2003/0088701 A1
(43) Pub. Date: May 8, 2003

(54) Establishing network addresses for network devices

(76) Inventor: Robert Warren Mross, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/011,516

(22) Filed: Nov. 5, 2001

(51) Int. Cl. G06F 15/16

(52) U.S. Cl. 709/245

(57) ABSTRACT

Methods for establishing network addresses are provided. A representative method includes: providing a first network device capable of exhibiting a predefined network address; and altering the predefined network address automatically such that the first network device uses a network address previously unused by the network. Systems and other methods also are provided.

### FIELD OF THE INVENTION

The present invention generally relates to computer networks. More specifically, the invention relates to systems and methods for establishing network addresses that can be used by network devices.

### DESCRIPTION OF THE RELATED ART

A computer network is formed of an intercommunicating arrangement of network devices. These network devices can include servers, workstations, printing devices, memory storage devices, etc. In order for network devices of a computer network to communicate with each other, each of the network devices is assigned a communication address, e.g., an Internet protocol (IP) address. Assigning an IP address to a network device typically is accomplished by an operator, such as an information technology (IT) support technician. To assign an IP address to a network device, the operator typically identifies one or more IP addresses of the computer network that are available for use. The operator then selects one of the available IP addresses and assigns the IP address to the network device.

An operator can determine addresses that are currently being used by a computer network by polling the network devices of the network, such as with a broadcast. In response to receiving the broadcast, each network device responds by communicating an associated IP address to the network, i.e., the network server. In this manner, the operator can compare the IP addresses currently being used to a known range of addresses that can be supported by the network.

Clearly, the aforementioned procedure requires a certain level of technical proficiency. Therefore, if a network device is to be added to a network, oftentimes, the network device cannot be made available for use until an IT support technician is able to assign the network device an address.

Based on the foregoing, it should be appreciated that there is a need for improved systems and methods that address these and/or other shortcomings of the prior art.

### SUMMARY OF THE INVENTION

The present invention relates to systems and methods for establishing network addresses. In this regard, a representative embodiment of one such method includes: providing a first network device capable of exhibiting a predefined network address; and altering the predefined network address automatically such that the first network device uses a network address previously unused by the network.

A representative system for establishing a network address includes a first network device. The first network device is capable of exhibiting a predefined network address and is configured to alter the predefined network address automatically. In this manner, the first network device can identify and use a network address previously unused by the network.

Another system for establishing a network address incorporates a first address selection system. The first address selection system is configured to enable a first network device to exhibit a predefined network address. The first address selection system also is configured to alter the predefined network address automatically so that the first network device uses a network address previously unused by the network.

Other features of the present invention will become apparent to one with skill in the art upon examination of the following drawings and detailed description. It is intended that all such features be included herein within the scope of the present invention, as defined in the appended claims.

### BRIEF DESCRIPTION OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting an embodiment of a computer network of the present invention.

FIG. 2 is a flowchart depicting functionality of the embodiment of the computer network depicted in FIG. 1.

FIG. 3 is a flowchart depicting functionality of the embodiment of the address selection system depicted in FIG. 1.

FIG. 4 is a schematic diagram depicting a computer or processor-based system that can be used to implement the embodiment of the address selection system depicted in FIG. 1.

FIG. 5 is a flowchart depicting functionality of the embodiment of the address selection system depicted in FIG. 4.

FIG. 6 is a flowchart depicting functionality of an alternative embodiment of the address selection system of FIG. 1.

### DETAILED DESCRIPTION

Systems and methods of the present invention potentially enable addresses, such as Internet protocol (IP) addresses, to be assigned to network devices. Preferably, this can be accomplished without the intervention of a skilled operator, who otherwise might be required to identify an available address and then configure the network device with the identified address. As will be described in greater detail herein, systems and methods of the invention preferably can automatically identify an available address(es) and then assign an available address(es) to a network device(s).

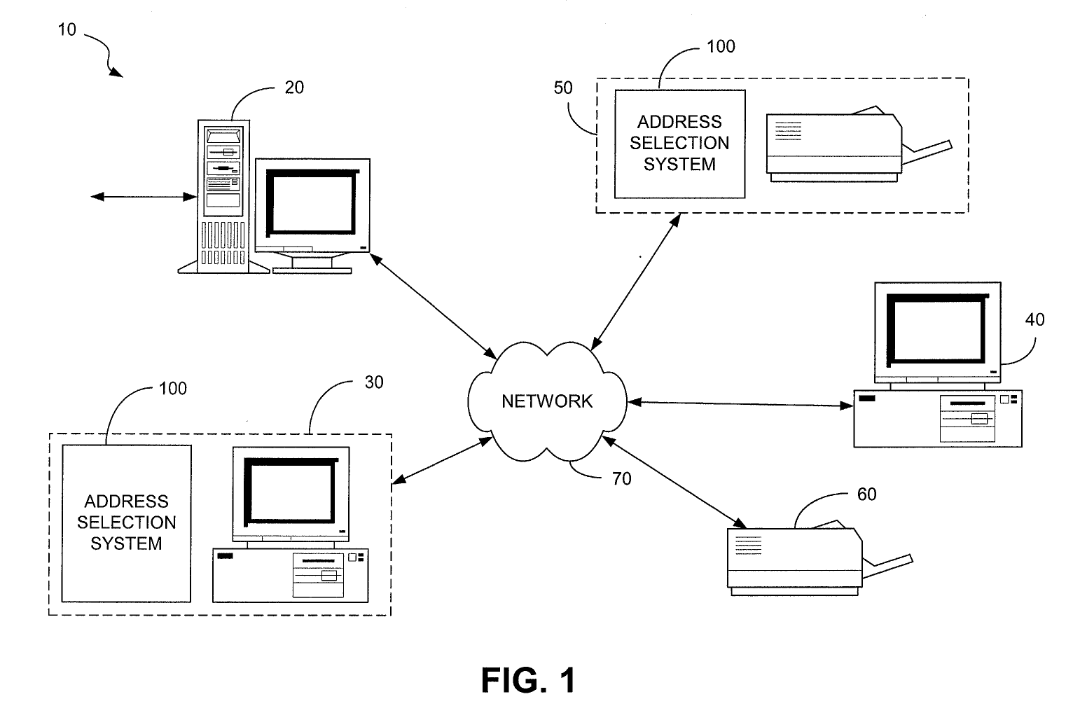

Referring now to the drawings, wherein like reference numerals indicate corresponding components throughout the several views, FIG. 1 is a schematic diagram depicting an embodiment of a network 10 of the present invention. As shown in FIG. 1, network 10 includes multiple network devices. More specifically, network 10 includes a server 20, e.g., a network server, workstations 30 and 40, and printing devices 50 and 60, each of which communicates with communication network 70. Note, various numbers and types of network devices other than those shown in FIG. 1 could be included in a network 10, such as an Internet-enabled appliance, e.g., a video cassette recorder that is configured to communicate with the Internet.

Network 70 may be any type of communication network employing any network topology, transmission medium, or network protocol. For example, network 70 may be any public or private packet-switched or other data network, including the Internet, circuit-switched networks, such as the public switched telephone network (PSTN), wireless network, or any other desired communications infrastructure and/or combination of infrastructures. Typically, however, network 70 is a Local Area Network (LAN). As will be described in detail below, when network 70 is a LAN, the assignment of network addresses to network devices can be limited to the assignment of internal IP addresses.

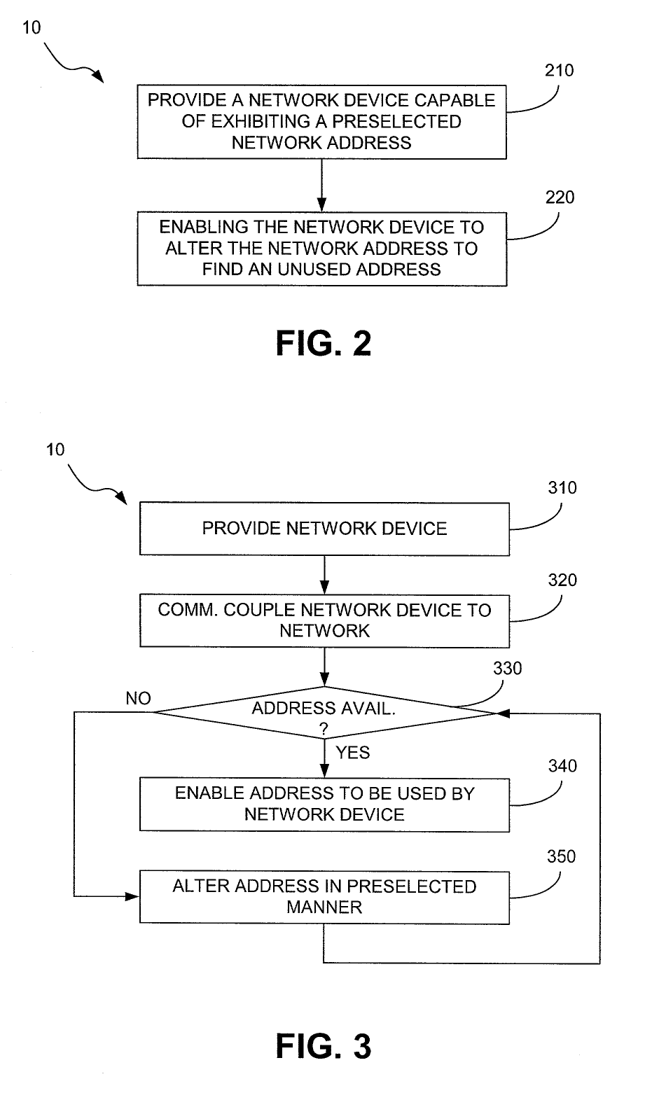

Functionality of the embodiment of the network 10 will now be described with reference to the flowchart of FIG. 2. As depicted in FIG. 2, the network 10 preferably includes a network device that is capable of exhibiting a pre-selected network address (block 210). In block 220, the network device is enabled to alter the pre-selected network address so that an unassigned network address can be identified. Once identified, the identified network address then can be used by the network device.

A process for assigning an address to a network device of network 10 is depicted in FIG. 3. As shown in the flowchart of FIG. 3, the process may be construed as beginning at block 310, where a network device is provided. In block 320, the network device is communicatively coupled to the network, e.g., network 10. In block 330, a determination is made as to whether a particular network address is available. More specifically, the determination may involve whether a pre-selected network address exhibited by the network device is available. If it is determined that the pre-selected network address is available, the process may proceed to block 340, where the pre-selected network address can be used by the network device. If, however, it is determined that the pre-selected network address is not available, the process may proceed to block 350. In block 350, the pre-selected network address can be altered in a pre-selected manner to correspond to a different address. Once altered to a new address, the process may return to block 330 and proceed as described before until an available network address is identified. The identified network address then can be used by the network device for communicating with the network.

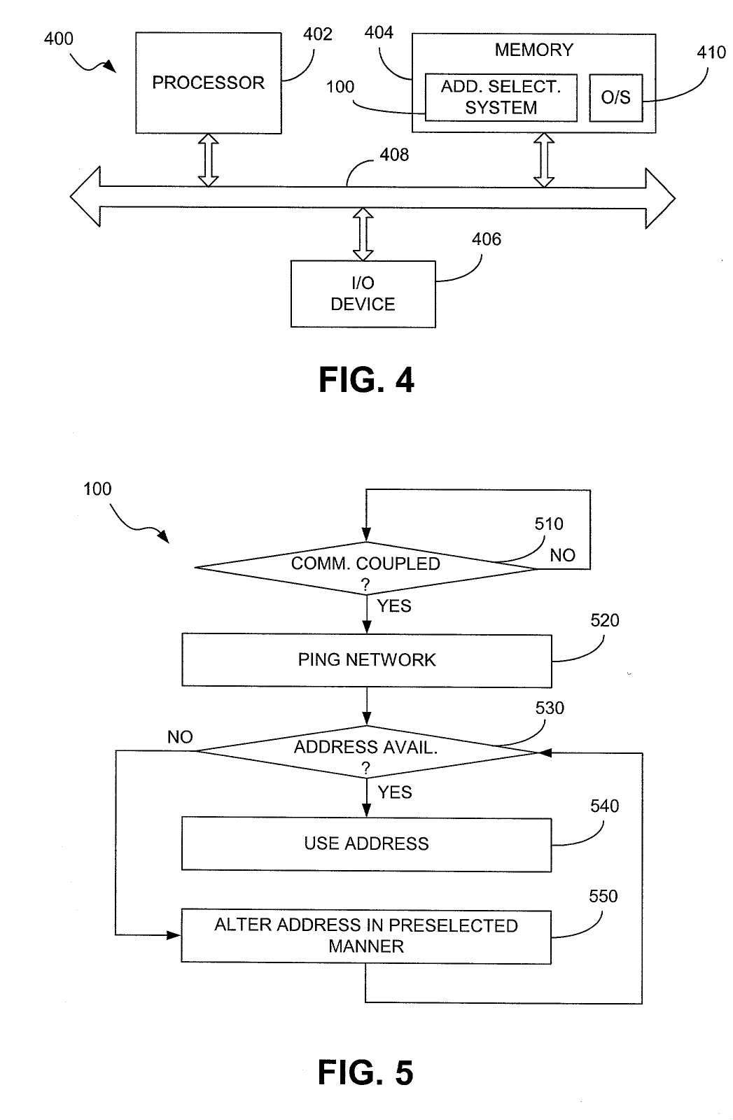

Referring back to FIG. 1, workstation 30 and printing device 60 are each associated with an address selection system 100. As will be described in greater detail below, an address selection system 100 can be used to identify and then establish a network address for an associated network device. Address selection systems 100 can be implemented in software, firmware, hardware, or a combination thereof. When implemented in software, an address selection system 100 can be a program that is executable by a computer or processor-based device (“computer”) 400, an example of which is depicted schematically in FIG. 4.

Generally, in terms of hardware architecture, computer 400 of FIG. 4 includes a processor 402, memory 404, and one or more input and/or output (I/O) devices 406 (or peripherals) that are communicatively coupled via a local interface 408. Local interface 408 can be, for example, one or more buses or other wired or wireless connections, as is known in the art. Local interface 408 can include additional elements, which are omitted for ease of description. These additional elements can be controllers, buffers (caches), drivers, repeaters, and/or receivers, for example. Further, the local interface may include address, control, and/or data connections to enable appropriate communications among the components of computer 400.

Processor 402 can be a hardware device configured to execute software that can be stored in memory 404. Processor 402 can be any custom made or commercially available processor, a central processing unit (CPU) or an auxiliary processor among several processors. Additionally, the processor can be a semiconductor-based microprocessor (in the form of a microchip), for example.

Memory 404 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 404 can incorporate electronic, magnetic, optical, and/or other types of storage media. Note that memory 404 can have a distributed architecture, where various components are situated remote from one another, but can be accessed by processor 402.

The software in memory 404 can include one or more separate programs, each of which comprises an ordered listing of executable instructions for implementing logical functions. The software in the memory 404 includes address selection system 100 and a suitable operating system (O/S) 410. The operating system 410 controls the execution of other computer programs, such as address selection system 100. Operating system 410 also can provide scheduling, input-output control, file and data management, memory management, and communication control and related services.

The I/O device(s) 406 can include input devices, such as a keypad and/or a receiver, for example. I/O device(s) 406 also can include output devices, such as a display device and/or a transmitter, for example. I/O device(s) 406 may further include devices that are configured to communicate both inputs and outputs, such as a network communication port, for example.

When the computer 400 is in operation, processor 402 is configured to execute software stored within the memory 404, communicate data to and from the memory 404, and generally control operations of the computer 400. Address selection system 100 and the O/S 410, in whole or in part, are read by the processor 402, perhaps buffered within processor 402, and then executed.

When address selection system 100 is implemented in software, it should be noted that the remote print system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Address selection system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

When implemented in hardware, address selection system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

Reference will now be made to the flowchart of FIG. 5, which depicts the functionality of a representative embodiment of address selection system 100. In this regard, each block of the flowchart represents a module segment or portion of code that comprises one or more executable instructions, or logic for implementing the specified logical function(s). It should also be noted that in some alternative implementations the functions noted in various blocks of FIG. 5, or any other of the accompanying flowcharts, may occur out of the order in which they are depicted. For example, two blocks shown in succession in FIG. 5 may, in fact, be executed substantially concurrently. In other embodiments, the blocks may sometimes be executed in the reverse order depending upon the functionality involved.

As shown in the flowchart of FIG. 5, the address selection system or method 100 may be construed as beginning at block 510, where a determination is made as to whether a network device, which is associated with the address selection system, is communicatively coupled to a computer network. If it is determined in block 510 that the network device is communicatively coupled to the network, the process may proceed to block 520. In block 520, the network device pings the network with a preselected address. In block 530, a determination is made as to whether the address that was pinged is available for use. In particular, the address selection system determines whether another network device responds to the ping. If no response is received, it is assumed that the address corresponding to the ping is not currently assigned. If it is determined that the address is available for use, the network device can use the pre-selected address when communicating with the network, such as depicted in block 540.

If it is determined in block 530 that the address is not available, i.e., another network device responded to the ping, the process may proceed to block 550. In block 550, the pre-selected address can be altered in a pre-selected manner. Thereafter, the process may return to block 520 where the network is pinged with the altered address, and proceeds as described before until an available address is identified.

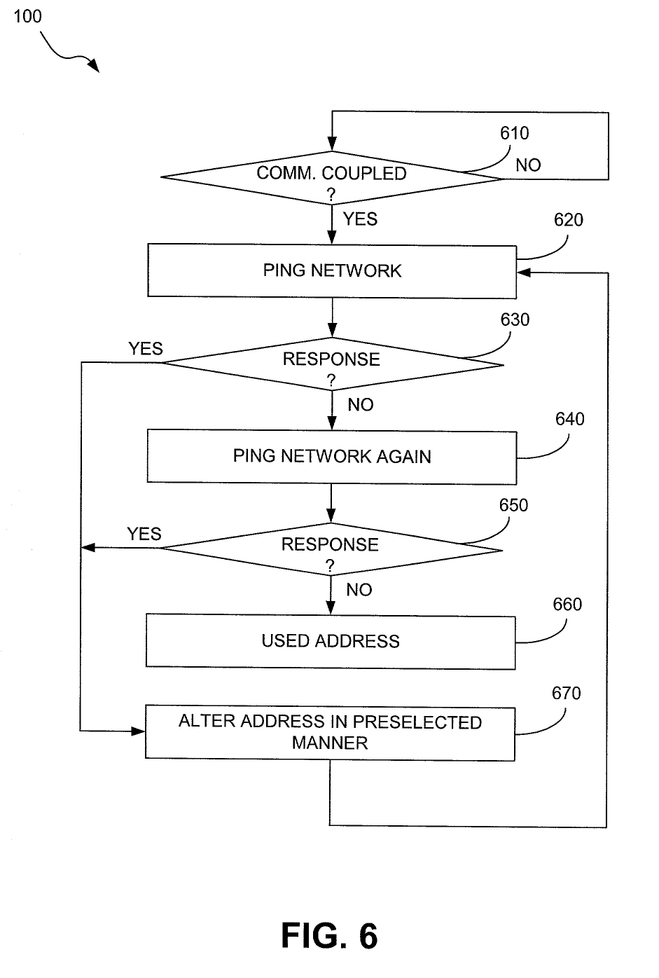

Functionality of another representative embodiment of address selection system 100 will now be described with reference to the flowchart of FIG. 6. As shown in FIG. 6, the address selection system or method 100 may be construed as beginning at block 610, where a determination is made as to whether a network device, which is associated with the address selection system, is communicatively coupled to a computer network. If it is determined in block 610 that the network device is communicatively coupled to the network, the process may proceed to block 620. In block 620, the network device pings the network with a pre-selected address.

In block 630, a determination is made as to whether another network device has responded to the ping. If no response is received, the process may proceed to block 640, where the network can be pinged once again with the pre-selected address. In block 650, another determination is made as to whether a network device has responded to the ping. If no response is received, it is assumed that the address corresponding to the ping is not currently assigned. Thereafter, the network device can use the pre-selected address when communicating with the network, such as depicted in block 660. Note, the process of pinging and determining whether a network device responds to a ping can be conducted a number of times other than that particularly shown in FIG. 6.

If it is determined, either in block 630 or 650, that the address is not available, i.e., another network device responded to a ping, the process may proceed to block 670. In block 670, the pre-selected address can be altered. It should be noted that the pre-selected address can be provided in any format that facilitates identification of an address that can be used by the network device. For instance, when the network device is an internal device associated with a LAN, the pre-selected address could be 010.000.000.001 or 010.255.255.255. When using the former, altering the preselected address can include increasing the address in a predetermined increment, such as by one. In contrast, when using the former, altering the pre-selected address can include decreasing the address in a predetermined increment.

Regardless of the particular technique used for altering the address, once the address has been altered, the network is pinged with the altered address (block 620) and proceed as described before, to determine whether the altered address is available for use.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated.

1. A method for establishing a network address for use with a network, said method comprising:
providing a first network device capable of exhibiting a predefined network address; and
altering the predefined network address automatically such that the first network device uses a network address previously unused by the network.

2. The method of claim 1, wherein altering the predefined network address automatically comprises:
determining whether the predefined network address is assigned to another network device of the network; and
if the predefined network address is not assigned to another network device of the network, using the predefined network address for the first network device.

3. The method of claim 2, wherein determining whether the predefined network address is assigned to another network device of the network comprises:
enabling the first network device to ping the predefined network address; and
determining whether another network device responds to the ping.

4. The method of claim 2, further comprising:
if the predefined network address is assigned to another network device of the network, altering the predefined network address automatically such that the first network device exhibits a first altered network address; and
determining whether the first altered network address is assigned to another network device of the network.

5. The method of claim 4, further comprising:
using the first altered network address for the first network device if the first altered network address is not assigned to another network device of the network.

6. The method of claim 4, wherein altering the predefined network address automatically comprises:
incrementing the predefined network address.

7. The method of claim 1, wherein the network is a Local Area Network; and
wherein the first network device is an internal network device.

8. A system for establishing a network address for use with a network, said system comprising:
a first network device capable of exhibiting a predefined network address, said first network device being configured to alter the predefined network address automatically such that the first network device uses a network address previously unused by the network.

9. The system of claim 8, wherein said first network device is configured to determine whether the predefined network address is assigned to another network device of the network and, if the predefined network address is not assigned to another network device of the network, use the predefined network address.

10. The system of claim 8, wherein said first network device further comprises:
means for determining whether the predefined network address is assigned to another network device of the network such that, if the predefined network address is not assigned to another network device of the network, said first network device uses the predefined network address.

11. The system of claim 8, wherein said first network device is configured to ping the predefined network address and determine whether another network device responds to the ping.

12. The system of claim 8, wherein said first network device further comprises:
means for pinging the predefined network address;
means for determining whether another network device responds to the pinging.

13. The system of claim 8, wherein said first network device further comprises:
an address selection system including logic, said logic being configured to alter the predefined network address automatically such that the first network device uses a network address previously unused by the network.

14. A system for establishing a network address for use with a network, said system comprising:
a first address selection system configured to enable a first network device to exhibit a predefined network address, said first address selection system being configured to alter the predefined network address automatically such that the first network device uses a network address previously unused by the network.

15. The system of claim 14, wherein said first address selection system is configured to determine whether the predefined network address is assigned to another network device of the network and, if the predefined network address is not assigned to another network device of the network, enable the first network device to use the predefined network address.

16. The system of claim 14, further comprising:
a first network device associated with said first address selection system.

17. The system of claim 14, wherein said first address selection system is embodied in a computer readable medium.

18. The system of claim 17, further comprising:
a second network device; and
a second address selection system configured to enable said second network device to exhibit a predefined network address, said second address selection system being configured to alter the predefined network address automatically such that the second network device uses a network address previously unused by the network.

19. The system of claim 17, further comprising:
a third network device lacking an address selection system.

20. The system of claim 17, wherein said first address selection system includes means for determining whether the predefined network address is assigned to another network device of the network such that, if the predefined network address is not assigned to another network device of the network, said first address selection system enables said first network device to use the predefined network address.
